(19) United States
(12) Patent Application Publication
(10) Pub. No.: US 2002/0134494 A1
(43) Pub. Date: Sep. 26, 2002

(54) Method and device for producing a corrugated sheet having a corrugation

(76) Inventors: Rolf Bruck, Bergisch Gladbach (DE); Meike Reizig, Erpel (DE)

Correspondence Address: LERNER AND GREENBERG, P.A., Post Office Box 2480, Hollywood, FL, 33022-2480, US

(21) Appl. No.: 10/113,634

(22) Filed: Mar. 27, 2002

Related U.S. Application Data
(63) Continuation of application No. PCT/EP00/08861, filed on Sep. 11, 2000.

(30) Foreign Application Priority Data
Sep. 13, 1999 (DE) 199 43 845.5
Nov. 30, 1999 (DE) 199 57 585.1

(51) Int. Cl. B31F 1/22; B31F 1/20

(52) U.S. Cl. 156/205; 156/462; 156/474; 156/486

(57) ABSTRACT

The invention relates to a method and to a device for producing a corrugated sheet that has a corrugation and that is especially used for a catalyst substrate. According tot eh inventive method, a sheet of a predetermined thickness of less than 0.06 mm is passed through two intermeshing rolls. Each roll has a profile that is made up of profile sections. A flank clearance between two opposite flanks of the profile sections is larger than the thickness of the sheet which is passed through the intermeshing rolls.

### CROSS-REFERENCE TO RELATED APPLICATION

This application is a continuation of copending International Application No. PCT/EP00/08861, filed Sep. 11, 2000, which designated the United States.

### BACKGROUND OF THE INVENTION

### FIELD OF THE INVENTION

The invention relates to a method and to a device for producing a corrugated sheet having a corrugation, with a thickness smaller than 0.06 mm, preferably smaller than 0.04 mm.

Such corrugated sheets are used, in particular, for forming a metallic honeycomb body. The honeycomb body may be employed as a catalyst carrier body for catalytic converters, in particular as catalytic converters for exhaust systems of motor vehicles. A honeycomb body of this type, particularly when it is capable of being heated electrically, may also be used as a reformer. The most diverse possible embodiments of honeycomb bodies are known. Reference is made, by way of example, to the disclosure content of EP 0 45 737 B1.

Various procedures for producing a corrugated sheet having a corrugation are known. WO 98/18557 proposes a method in which a structure is introduced into a striplike metal sheet. The height of the structure is in this case greater than a desired structure height. A calibrating step then follows, in which a force is exerted on the structure of the metal sheet, so that, after the calibrating step, the height of the structure corresponds to the desired structure height.

To form the structure, which is a corrugation, it is proposed, according to WO 98/18557, that the metal sheet be led through between two intermeshing corrugating rolls.

WO 98/09745, furthermore, discloses a method for producing a corrugated sheet having a corrugation, with a microstructure.

According to this method, first, a microstructure is introduced into an uncorrugated metal sheet. The metal sheet is then fed to a pair of intermeshing metal rolls which have built-on pieces for receiving the microstructure, said built-on pieces being arranged longitudinally with respect to the microstructure. While the metal sheet is being led through between the corrugating rolls, the formation of a corrugation of the metal sheet takes place, without the microstructures being pressed flat.

It was found that a corrugated sheet which has a corrugation tends to roll up. The inclination of the corrugated sheet to roll up is dependent, inter alia, on the thickness of the sheet. The thinner the sheet is, the more it is inclined to roll up. In the light of the fact that honeycomb bodies are employed as catalyst carrier bodies for catalytic converters, in particular as catalytic converters for exhaust systems of motor vehicles, it is desirable that the corrugated sheet has as small a thickness as possible. The advantage of this is that the heat capacity of such a honeycomb body is reduced, so that the honeycomb body can reach its working temperature relatively quickly. Particularly with regard to a honeycomb body which is capable of being heated electrically, the reduced heat capacity of the honeycomb body has advantages. Such a tendency is irrespective of whether the metal strip is unwound from a coil and led between intermeshing corrugating rolls or whether a planar smooth metal sheet is led through between the corrugating rolls. What is achieved by a microstructure being introduced into the corrugated sheet is that a rolling up of the corrugated sheet is reduced or prevented.

The inclination of the corrugated sheet to roll up causes trouble particularly when the corrugated sheet is divided into sheet strips of defined length after the corrugation-forming operation. The individual sheet strips may have different flexions. The individual sheet strips may also roll up spirally, in which case the spirally wound sheet strips may assume different shapes. In particular, the spirally wound sheet strips may vary.

If the sheet strips are stacked into a stack, the flexed shape of the sheet strips makes it difficult to handle the stack.

A reproducibility of the flexion or of the rolling-up behavior of the sheet strip was not possible by the known means, particularly with regard to the intensity or the flexing or rolling-up direction.

### SUMMARY OF THE INVENTION

Proceeding from this, the aim on which the present invention is based is to specify a method and a device, by means of which a corrugated sheet can be produced which has no or only a very slight inclination to rolling up. A further aim of the invention is to specify a method and a device, by means of which a specific inclination of the corrugated sheet to roll up can be set.

These aims are achieved by means of the methods according to the invention having the features of claim 1 and of claim 2 and by means of the devices having the features of claim 9 and of claim 14. Advantageous developments and refinements of the methods and of the devices are the subject matter of the dependent claims.

It was found that a corrugated sheet with a thickness D, in particular with a thickness D smaller than 0.06 mm, preferably smaller than 0.04 mm, can be produced when it is led through between two intermeshing rolls which each have a profile formed by profile segments and the flank clearance between two opposite flanks of the profile segments is greater than the thickness of the sheet. Such a corrugated sheet has no or only a very slight inclination to roll up. The procedure according to the invention is reduced a reduction in the tensile and compressive forces on the sheet. A reduction in friction is also achieved.

When such a corrugated sheet is divided into sheet strips of predetermined length and the sheet strips are layered one on the other to form a stack, the sheet strips thus lie essentially parallel to one another. In the sheet strips, the inclination is also reduced, since the ends of the sheet strips lift off. It is thereby possible to provide a sheet stack which is easier and simpler to handle. A honeycomb body can be produced from such a sheet stack.

With regard to a profile segment of a roll, this profile segment engages between two profile segments of the opposite roll. The flank clearance is preferably designed, on both sides of the profile segment of one roll which engages between two profile segments of the other roll, in such a way that the flank clearance between two flanks of the adjacent profile segments is greater than the thickness of the sheet. The advantages of the method according to the invention are achieved even when the flank clearance is provided on only one side with respect to the profile segments.

According to a further inventive idea, a method for producing a metal sheet having a corrugation is proposed, in which a sheet is led through a thickness between two intermeshing corrugating rolls which each have a profile formed by profile segments, at least a part of the profile segments of at least one of the two corrugating rolls by which the sheet is deformed being designed in such a way that the profile segments have a head and a shank extending from the head to the foot, the shank having two opposite flanks, and at least one of the flanks running essentially parallel to a center line of the profile segment. What is also achieved by such a procedure is that the sheet produced has essentially no inclination to curve or roll up about an axis running transversely to the longitudinal direction of the sheet.

Preferably, the production of a corrugated sheet having a corrugation is carried out in such a way that the corrugated sheet is deformed by profile segments which have a head of essentially rounded cross section and a shank extending from the head to the foot, the shank having an essentially uniform width. What is achieved by this advantageous development of the method is that the inclination of the corrugated sheet to roll up is minimized even further.

At least one corrugating roll is driven. If only one corrugating roll is driven, the other corrugating roll is drawn by the sheet. This may lead to uneven stress on the sheet. In the case of very thin sheets, particularly as regards metal foils with a thickness smaller than 50 μm, there is the risk that the metal foil will be damaged when the corrugating roller is being drawn. An uneven formation of the corrugated profile may also occur. It is therefore proposed that both corrugated rolls be driven. Each roll may have its own drive, these drives allowing a synchronous movement of the corrugating rolls by appropriate control means. To simplify the management of the process, however, it is proposed that only one corrugating roll be driven by a drive unit, the two corrugating rolls being connected kinematically to one another. The connection may be made, for example, by means of an appropriate gear or coupling system.

For different applications of the corrugated sheet, it may be necessary to produce corrugated sheets with different corrugation heights. It is therefore proposed to make the distance between the longitudinal axes of the corrugating rolls adjustable.

The shape of the corrugation can also be influenced by virtue of the adjustability of the distance between the longitudinal axes of the corrugating rolls. It was found that, by a variation in the distance between the longitudinal axes of the corrugating rolls, the shape of the corrugation can be changed from an essentially sinusoidal corrugation to a sawtooth shaped corrugation. The change in the distance between the longitudinal axes of the corrugating rolls also affords the possibility of achieving a specific and reproducible curvature of the corrugated sheet about an axis running essentially transversely to the longitudinal axis of the sheet. It is also possible, by means of an appropriate setting of the distance between the longitudinal axis of the corrugating rolls, to influence the inclination of the corrugated sheet to roll up.

According to yet another advantageous idea, it is proposed that the sheet be led through, essentially free of lubricant, between the corrugating rolls. A complicated cleaning of the corrugated sheet is thereby avoided. Such may be necessary when a honeycomb body is to be soldered.

According to a further refinement of the method, the corrugating rolls generate a corrugated sheet with a predeterminable wavelength and wave height, the ratio of wavelength to wave height being lower than 2.5, preferably lower than 1.5. Particularly for very thin sheets, the method according to the invention makes it possible to have a very large wave height in relation to the wave length, because, during forming, only very low tensile and compressive forces are introduced into the sheets because of the flank clearance.

According to yet another inventive idea, a device for producing a corrugated sheet having a corrugation by means of two intermeshing corrugating rolls, between which a sheet for a catalyst carrier body, with a thickness D, in particular with a thickness D smaller than 0.06 mm, preferably smaller than 0.04 mm, can be led, is proposed, each corrugating roll having a profile which is formed by profile segments, and the flank clearance between two opposite flanks of the profile segments being greater than the thickness of sheet. What is achieved by such a device is that the product, a corrugated sheet, has no or only a very slight inclination to flex or roll up about an axis running essentially transversely to the longitudinal axis of the corrugated sheet.

According to yet another inventive idea, a device for producing a corrugated sheet having a corrugation by means of two intermeshing corrugating rolls, between which a sheet for a catalyst carrier body with a thickness D, in particular with a thickness D smaller than 0.06 mm, preferably smaller than 0.04 mm, can be led, is proposed, at least a part of the profile segments with at least one of the two corrugating rolls by which the sheet is deformed being designed in such a way that the profile segments have a head and a shank extending from the head to the foot, the shank having two opposite flanks, and at least one of the flanks running essentially parallel to a center line of the profile segment.

Preferably, each roll has a profile which is formed by profile segments, the profile segments having a head of essentially rounded cross section and a shank extending from the head to the foot and having an essentially uniform width.

According to an advantageous refinement of the device, the profile segments are designed in such a way that a corrugated sheet with a wave length and a wave height can be produced, the ratio of wave length to wave height being lower than 2.5. Preferably, the ratio is lower than 1.5 and, in particular, lower than 1. At the same time, it is particularly advantageous to make the profile segments very slender, in particular with a corresponding ratio of height and width of the profile segments. The stresses on the thin sheets during forming are low because of the flank clearance, in such a way that such thin sheets are produced essentially without the inclination to curve or roll up about an axis running transversely to the longitudinal axis of the sheet. Precisely where very thin sheets are concerned, therefore, an additional flexing operation, which may lead to material fatigue or embrittlement, can be avoided.

Furthermore, a use of the device according to the invention for producing a corrugated sheet for a catalyst carrier body is proposed, the catalyst carrier body comprising a casing tube and a honeycomb body, and the honeycomb body having at least partially corrugated sheets which has a multiplicity of ducts through which a fluid is capable of flowing, the corrugated sheets having a ratio of wave length to wave height lower than 2.5, in particular lower than 1.5. Such metallic honeycomb bodies usually have a number of sheet plies with smooth sheets and corrugated sheets which are coiled or twisted with one another. Where such a honeycomb body is concerned, the number of sheet plies can be reduced by means of the corrugated sheets produced by the device according to the invention, on account of the specified ratio of wave length to wave height. As a result, for example, the weight (by virtue of the smaller number of smooth sheets), the pressure loss (owing to changed flow conditions in the region of the gusset during the throughflow of an exhaust gas) and, if appropriate, also the quantity of an applied catalytically active coating of the catalyst carrier body are reduced. In addition, such a honeycomb body has higher rigidity, particularly in the edge regions near the casing tube, on account of the narrow duct shape with the steep flanks.

Other features which are considered as characteristic for the invention are set forth in the appended claims.

Although the invention is illustrated and described herein as embodied in a method and device for producing a corrugated sheet having a corrugation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows diagrammatically an embodiment of a device for producing a corrugated sheet having a corrugation,

FIG. 2 shows, enlarged, a profile of a corrugating roll,

FIG. 3 shows diagrammatically, enlarged, a region of engagement of two corrugating rolls,

FIG. 4 shows a region of engagement of two corrugating rolls with a sheet located in the region of engagement,

FIG. 5 shows a catalyst carrier body with a corrugated sheet produced according to the invention, and

FIG. 6 shows a view of a detail of a corrugated sheet.

### DESCRIPTION OF THE PREFERRED EMBODIMENTS

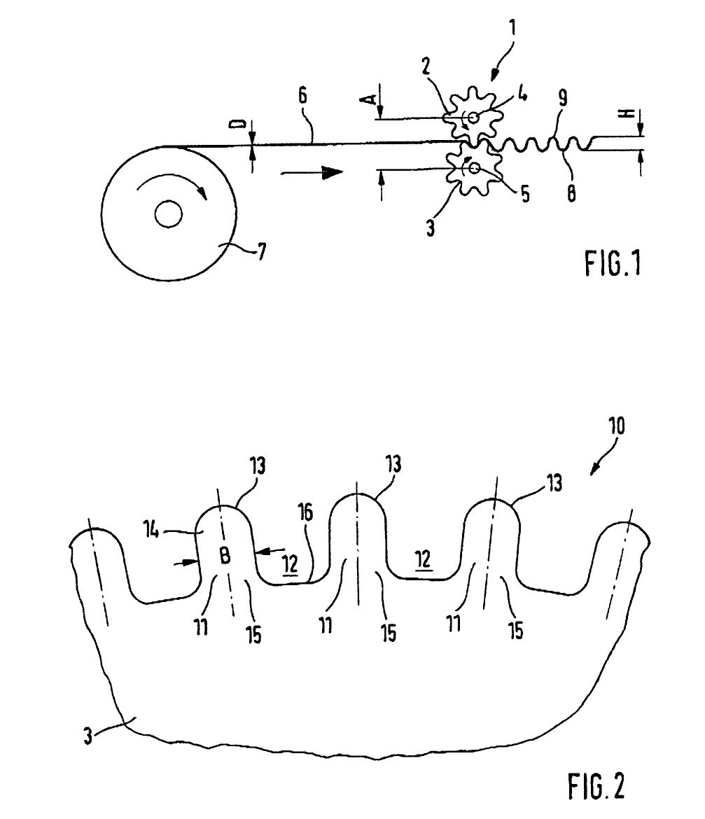

FIG. 1 shows diagrammatically a device 1 for producing a corrugated sheet 8. The device 1 comprises two intermeshing corrugating rolls 2, 3. The axes 4, 5 of the corrugating rolls 2, 3 run parallel to one another. The distance between the longitudinal axes 4, 5 is designated by A.

Between the corrugating rolls 2, 3 runs a striplike sheet 6 which is unwound from a coil 7. The sheet 6 has a thickness D.

While the sheet 6 is running through between the corrugating rolls 2, 3, a corrugation 9 is imparted to the sheet 6. The corrugated sheet 8 can be supplied for further processing. The corrugation 9 of the corrugated sheet 8 has a corrugation height H.

In FIG. 1, the illustration of the drive units or of the drive unit for the corrugating rolls 2, 3 has been dispensed with for the sake of greater clarity. The corrugating rolls are preferably connected kinematically to one another. In particular, one of the corrugating rolls 2, 3 is driven by a drive unit which may be, for example, an electric motor.

FIG. 2 shows diagrammatically, enlarged, a corrugating roll 3. The corrugating roll 2 is also designed correspondingly.

The corrugating roll 3 has a profile 10. The profile 10 is formed by a plurality of profile segments arranged on the circumference of the roll and at a distance from one another. Gaps 12 are formed in each case between the adjacent profile segments 11. Each profile segment has an essentially rounded head 13. A shank 14 extends from the head 13 to the foot 15. This shank 14 has an essentially uniform width B. The transition between the shank 14 and the gap bottom 16 is rounded in the foot region.

Each shank 14 has two opposite flanks 18, 20. In the exemplary embodiment illustrated, the two flanks run essentially parallel to a center line 21 of the profile segment. This is not absolutely necessary. A part of the profile segments 11 may be designed in such a way that the profile segments 11 have a head and a shank 14 extending from the head 13 to the foot 15, the flank 18 or 20 running essentially parallel to the center line 21 of the profile segment 11. The corrugating rolls 2, 3 may have profiles of different geometry. The rotational movement of the corrugating rolls is preferably synchronized.

The profiles 11 illustrated in FIG. 2 are formed by a head 13 which is designed with a semicircular cross section. The width B of the shank 14 in this case corresponds to the diameter of the semicircle of the head 13.

FIG. 3 shows a region of engagement of the intermeshing corrugating rolls 2, 3. The configuration of the profiles 10 of the corrugating rolls 2, 3 is identical in the exemplary embodiment illustrated.

It is evident from FIG. 3 that the profiles 10 of the corrugating rolls 2, 3 are designed in such a way that a flank clearance F between two opposite flanks 17, 18 is dimensioned such that the individual flanks of the profile segments do not roll on one another. The flank clearance F can be varied by varying the distance A between the longitudinal axes 4, 5 of the corrugating rolls.

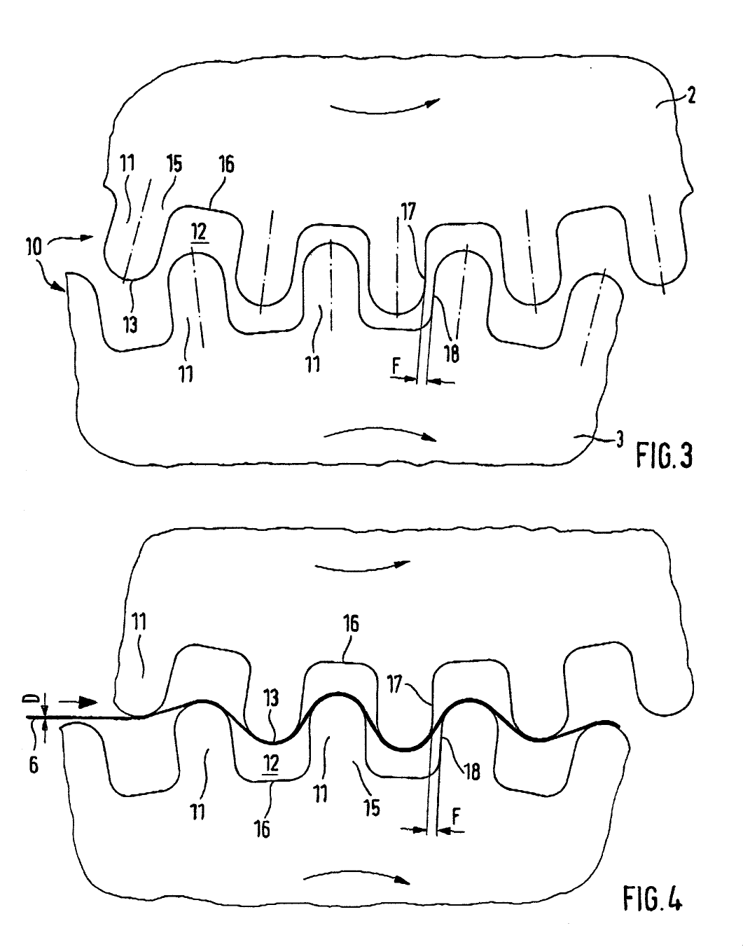

Preferably, the flank clearance F is greater than the thickness of a sheet 6, as illustrated in FIG. 4. FIG. 4 shows the region of engagement, illustrated in FIG. 3, with a sheet 6 of thickness D.

FIG. 4 shows diagrammatically that the sheet 6 is not squeezed between the flanks 17, 18. The formation of the corrugation 9 is carried out essentially by means of flexing and drawing operations.

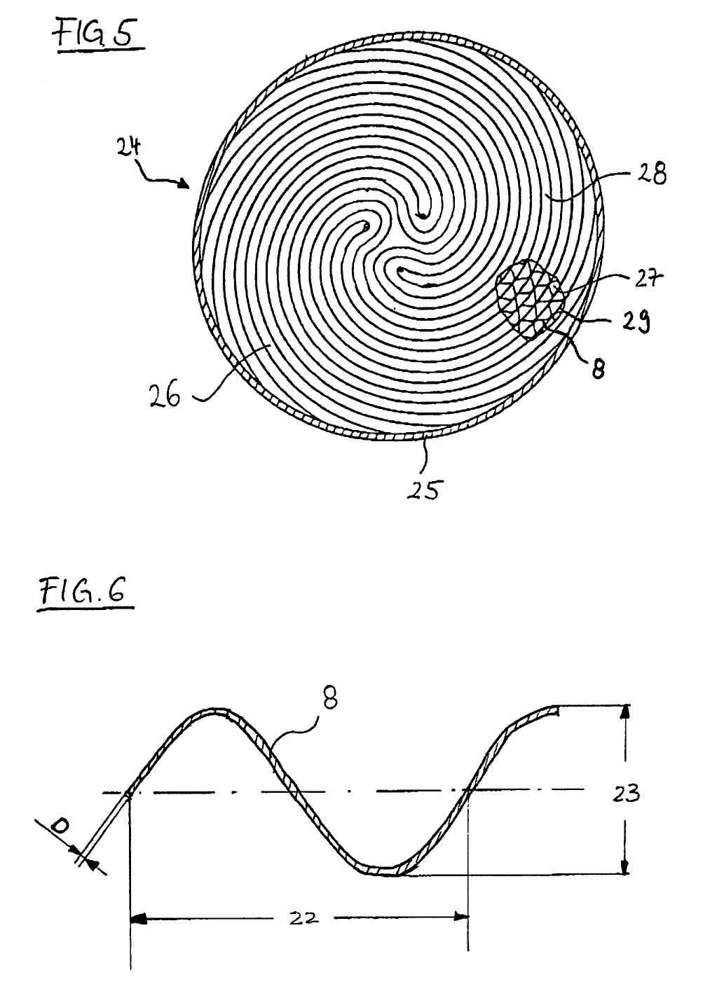

FIG. 5 shows diagrammatically a top view of a catalyst carrier body 24 with a corrugated sheet 8 produced according to the invention. The catalyst carrier body 24 has a casing tube 25 surrounding a number of sheet plies 28 which are structured in such a way that they form ducts 27 through which an exhaust gas is capable of flowing. The sheet plies 28 comprise smooth sheets 29 and corrugated sheets 8.

FIG. 6 shows a view of a detail of a corrugated sheet 8 with a thickness D and with a wave length 22 and a wave height 23. The illustrated ratio of wave length 22 to wave height 23 corresponds approximately to 2.

We claim:

1. A method for producing a corrugated sheet (8) having a corrugation (9), in which a sheet (6) for a catalyst carrier body with a thickness (D) smaller than 0.06 mm, preferably smaller than 0.04 mm, is led through between two intermeshing corrugating rolls (2, 3) which each have a profile (10) formed by profile segments (11) and a flank clearance (F) between two opposite flanks (17, 18) of the profile segments (10) is greater than the thickness (D) of the sheet (6).

2. The method for producing a corrugated sheet (8) having a corrugation (9), particularly as claimed in claim 1, in which a sheet (6) of a thickness (D) is led through between two intermeshing corrugating rolls (2, 3) which each have a profile (10) formed by profile segments (11), at least a part of the profile segments (11) have at least one of the two corrugating rolls (2, 3) by which the sheet (6) is deformed being designed in such a way that the profile segments (11) have a head (13) and a shank (14) extending from the head (13) to the foot (15), the shank (14) having two opposite flanks (17, 19; 18, 20), and at least one of the flanks (17, 19; 18, 20) running essentially parallel to a center line (21) of the profile segment (11).

3. The method as claimed in claim 1, in which both corrugating rolls (2, 3) are driven.

4. The method as claimed in claim 3, in which one corrugating roll (2, 3) is driven by a drive unit, the two corrugating rolls (2, 3) being connected kinematically to one another.

5. The method as claimed in one of claim 1, in which the distance (A) between the longitudinal axes (3, 5) of the corrugating rolls (2, 3) is set.

6. The method as claimed in one of claim 1, in which the flank clearance (F) between two opposite flanks (17, 18) of the profile segments (11) is set.

7. The method as claimed in one of claim 1, in which the sheet (6) is led through, essentially free of lubricant, between the corrugating rolls (2, 3).

8. The method as claimed in one of claim 1, in which the corrugating rolls (2, 3) generate a corrugated sheet (8) with a wave length (22) and a wave height (23), the ratio of wave length (22) to wave height (23) being lower than 2.5, preferably lower than 1.5.

9. A device for producing a corrugated sheet (8) having a corrugation (9), having two intermeshing corrugating rolls (2, 3), between which a sheet (6) for a catalyst carrier body with a thickness (D) smaller than 0.06 mm, preferably smaller than 0.04 mm, can be led through, characterized in that each corrugating roll (2, 3) has a profile (10) which is formed by profile segments (11) and the flank clearance (F) between two opposite flanks (17, 18) of the profile segments (11) is greater than the thickness (D) of the sheet (6).

10. The device as claimed in claim 9, characterized in that both corrugating rolls (2, 3) are capable of being driven.

11. The device as claimed in claim 10, characterized in that one corrugating roll (2, 3) is capable of being driven by a drive unit, the two corrugating rolls (2, 3) being connected kinematically to one another.

12. The device as claimed in claim 9, characterized in that the distance (A) between the longitudinal axes (4, 5) of the corrugating rolls (2, 3) is adjustable.

13. The device as claimed in one of claim 9, characterized in that the flank clearance (F) between two opposite flanks (17, 18) of the profile segments (11) is adjustable.

14. The device for producing a corrugated sheet (8) having a corrugation (9), having two intermeshing corrugating rolls (2, 3), between which a sheet (6) for a catalyst carrier body with a thickness (D) smaller than 0.06 mm, preferably smaller than 0.04 mm, can be led through, in particular as claimed in one of claims 9 to 13, characterized in that at least a part of the profile segments (11) of at least one of the two corrugating rolls (2, 3) by which the sheet (6) is deformed is designed in such a way that the profile segments (11) have a head (13) and a shank (14) extending from the head (13) to the foot (15), the shank (14) having two opposite flanks (17, 19; 18, 20), and at least one of the flanks (17, 19; 18, 20) running essentially parallel to a center line (21) of the profile segment (11).

15. The device as claimed in claim 14, characterized in that the profile segments (11) have a head (13) of essentially rounded cross section and a shank (14) extending from the head (13) to the foot (15) and having an essentially uniform width (B).

16. The device as claimed in one of claim 9, in which the profile segments (11) are designed in such a way that a corrugated sheet (8) with a wave length (22) and a wave height (23) can be produced, the ratio of wave length (22) to wave height (23) being lower than 2.5, preferably lower than 1.5.

17. A method of using the device as claimed in claim 9 for producing a corrugated sheet (8) for a catalyst carrier body (24), the catalyst carrier body (24) comprising a casing tube (25) and a honeycomb body (26), and the honeycomb body (26) having at least partially corrugated sheets (8) having a multiplicity of ducts (27) through which a fluid is capable of flowing, the corrugated sheets (8) having a ratio of wave length (22) to wave height (23) lower than 2.5, in particular lower than 1.5.
